(19) United States
(12) Patent Application Publication
(10) Pub. No.: US 2015/0178291 A1
(43) Pub. Date: Jun. 25, 2015

(54) WIRELESS DISPLAY WITH AUDIO SKIPPING

(71) Applicants: Inching Chen, Portland, OR (US); Chinh T. Cao, Beaverton, OR (US); Sherine Abdelhak, Beaverton, OR (US); Anshuman Thakur, Beaverton, OR (US)

(72) Inventors: Inching Chen, Portland, OR (US); Chinh T. Cao, Beaverton, OR (US); Sherine Abdelhak, Beaverton, OR (US); Anshuman Thakur, Beaverton, OR (US)

(21) Appl. No.: 14/136,696

(22) Filed: Dec. 20, 2013

(51) Int. Cl. G06F 17/30

(52) U.S. Cl. CPC G06F 17/3074

(57) ABSTRACT

This disclosure describes systems, methods, and computer-readable media related to wireless displays with audio skipping. In some embodiments, a plurality of audio packets may be captured. Each of the plurality of audio packets may be analyzed. Analyzing the packets may include determining whether an audio packet of the plurality of audio packets is silent. In response to determining the audio packet of the plurality of audio packets is not silent, an audio non-skip mode may be entered. In response to determining the audio packet of the plurality of audio packets is silent, a determination may be made as to whether an indicator has exceeded a threshold. The indicator may indicate a sequential number of silent audio packets. In response to the indicator indicating the indicator exceeds the threshold, an audio skip mode may be entered. In response to the indicator indicating the indicator has not exceeded the threshold, the audio non-skip mode may be entered.

### BACKGROUND

As technology advances, devices become increasingly more powerful. For example, smartphones and tablets may be capable of making phone calls, surfing the Internet, paying bills, maintaining records, capturing videos and photographs, and the like. Televisions may be connected to a wireless network and may retrieve and display content from other devices as well as record content to a remote server. Such features may require an increased consumption of power to enable connectivity and functionality and may result in depleted batteries of the devices.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 depicts a block diagram including various hardware and software components of an illustrative system architecture for a wireless display (WiDi) with audio skip in accordance with one or more embodiments of the disclosure.

FIG. 2 is a block diagram including various hardware and software components of an illustrative system architecture for a WiDi transmitter in accordance with one or more embodiments of the disclosure.

FIG. 3 is a block diagram including various hardware and software components of an illustrative system architecture for a WiDi receiver in accordance with one or more embodiments of the disclosure.

FIG. 4 is a process flow diagram of an illustrative method for audio skip in a wireless display in accordance with one or more embodiments of the disclosure.

FIG. 5 is a process flow diagram of an illustrative method for detecting if an audio packet is silent in accordance with one or more embodiments of the disclosure.

### DETAILED DESCRIPTION

This disclosure relates to, among other things, systems, methods, computer-readable media, techniques, and methodology for a wireless display (WiDi) with audio skipping functionality. A WiDi may be a device that enables users to stream music, movies, photos, videos, and/or applications wirelessly from a computing device (e.g., laptop, smartphone, tablet, etc.) to a television, such as a high definition television with an integrated receiver or in conjunction with an adapter. A WiDi may be equipped with a power saving mode (PSM) for video to reduce platform power and Wi-Fi bandwidth when there is no video frame update. However, the WiDi may continue to capture, encode, and transmit audio even if the audio is silent. This disclosure is directed to a WiDi with audio skipping for power saving and network bandwidth reduction.

A WiDi with audio skipping may provide several benefits. For example, a WiDi with audio skip may save power of the WiDi and reduce the network bandwidth in an associated network. A WiDi may support several mode. For example, in a movie playback mode, advanced audio coding (AAC) compressed audio may be used. With audio skipping, AAC audio encode may be disabled, thus reducing power consumption of the WiDi. Similarly, in a low delay mode, uncompressed linear pulse-code modulation (LPCM) audio may be used. Audio skipping may reduce the Wi-Fi bandwidth.

Audio skipping may include capturing audio, identifying sections or portions of the audio that are silent or have no audio. Once identified, those sections or portions of the audio may not be encoded, may not be transmitted, or both.

Various illustrative embodiments have been discussed above. These and other example embodiments of the disclosure will be described in more detail hereinafter through reference to the accompanying drawings. The drawings and the corresponding description are provided merely for illustration and are not intended to limit the disclosure in any way. It should be appreciated that numerous other embodiments, variations, and so forth are within the scope of this disclosure.

### Illustrative Use Cases and System Architecture

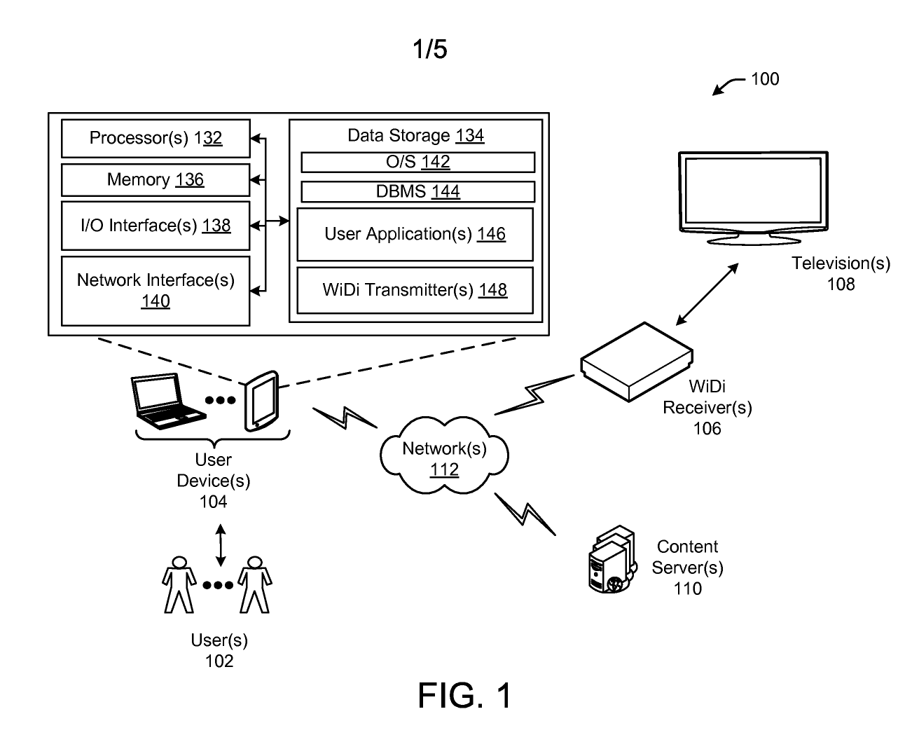

FIG. 1 depicts a block diagram including various hardware and software components of an illustrative system architecture for wireless displays with audio skip functionality in accordance with one or more embodiments of the disclosure. The illustrative system architecture 100 may include one or more user devices 104 operable by one or more user(s) 102, one or more wireless display (WiDi) receiver(s) 106, one or more televisions (TVs) or monitor(s) 108, and/or one or more content server(s) 110. The user device(s) 104 may include one or more WiDi transmitter(s) 148. The user device(s) 104 may include any suitable processor-driven computing device including, but not limited to, a desktop computing device, a laptop computing device, a server, a smartphone, a tablet, and so forth. For ease of explanation, the user device(s) 104, WiDi receiver(s) 106, TVs or monitor(s) 108, and/or content server(s) 110 may be described herein in the singular; however, it should be appreciated that multiple user device(s) 104, WiDi receiver(s) 106, TVs or monitor(s) 108, and/or content server(s) 110 may be provided.

Any of the user device(s) 104, WiDi receiver(s) 106, TVs or monitor(s) 108, and/or content server(s) 110 may be configured to communicate with each other and any other component of the system architecture 100 via one or more network(s) 112. The network(s) 112 may include, but are not limited to, any one or a combination of different types of suitable communications networks such as, for example, cable networks, public networks (e.g., the Internet), private networks, wireless networks, cellular networks, or any other suitable private and/or public networks. Further, the network(s) 112 may have any suitable communication range associated therewith and may include, for example, global networks (e.g., the Internet), metropolitan area networks (MANs), wide area networks (WANs), local area networks (LANs), or personal area networks (PANs). In addition, the network(s) 112 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The user device(s) 104 may include one or more processors (processor(s)) 132 and one or more memories 136 (referred to herein generically as memory 136). The processor(s) 132 may include any suitable processing unit capable of accepting digital data as input, processing the input data based on stored computer-executable instructions, and generating output data. The computer-executable instructions may be stored, for example, in the data storage 134 and may include, among other things, operating system software and application software. The computer-executable instructions may be retrieved from the data storage 134 and loaded into the memory 136 as needed for execution. The processor(s) 132 may be configured to execute the computer-executable instructions to cause various operations to be performed. The processor(s) 132 may include any type of processing unit including, but not limited to, a central processing unit, a microprocessor, a microcontroller, a Reduced Instruction Set Computer (RISC) microprocessor, a Complex Instruction Set Computer (CISC) microprocessor, an Application Specific Integrated Circuit (ASIC), a System-on-a-Chip (SoC), a field-programmable gate array (FPGA), and so forth.

The data storage 134 may store program instructions that are loadable and executable by the processor(s) 132, as well as data manipulated and generated by the processor(s) 132 during execution of the program instructions. The program instructions may be loaded into the memory 136 as needed for execution. Depending on the configuration and implementation of the user device(s) 104, the memory 136 may be volatile memory (memory that is not configured to retain stored information when not supplied with power) such as random access memory (RAM) and/or non-volatile memory (memory that is configured to retain stored information even when not supplied with power) such as read-only memory (ROM), flash memory, and so forth. In various implementations, the memory 136 may include multiple different types of memory, such as various forms of static random access memory (SRAM), various forms of dynamic random access memory (DRAM), unalterable ROM, and/or writeable variants of ROM such as electrically erasable programmable read-only memory (EEPROM), flash memory, and so forth.

The user device(s) 104 may further include additional data storage 134 such as removable storage and/or non-removable storage including, but not limited to, magnetic storage, optical disk storage, and/or tape storage. Data storage 134 may provide non-volatile storage of computer-executable instructions and other data. The memory 136 and/or the data storage 134, removable and/or non-removable, are examples of computer-readable storage media (CRSM).

The user device(s) 104 may further include network interface(s) 140 that facilitate communication between the user device(s) 104 and other devices of the illustrative system architecture 100 (e.g., WiDi receiver(s) 106, TV(s) 108, content server(s) 110, etc.) or application software via the network(s) 112. The user device(s) 104 may additionally include one or more input/output (I/O) interfaces 138 (and optionally associated software components such as device drivers) that may support interaction between a user 102 and a variety of I/O devices, such as a keyboard, a mouse, a pen, a pointing device, a voice input device, a touch input device, a display, speakers, a camera, a microphone, a printer, and so forth.

Referring again to the data storage 134, various program modules, applications, or the like may be stored therein that may comprise computer-executable instructions that when executed by the processor(s) 132 cause various operations to be performed. The memory 136 may have loaded from the data storage 134 one or more operating systems (O/S) 142 that may provide an interface between other application software (e.g., dedicated applications, a browser application, a web-based application, a distributed client-server application, etc.) executing on the user device 104 and the hardware resources of the user device 104. More specifically, the O/S 142 may include a set of computer-executable instructions for managing the hardware resources of the user device(s) 104 and for providing common services to other application programs (e.g., managing memory allocation among various application programs). The O/S 142 may include any operating system now known or which may be developed in the future including, but not limited to, any mobile operating system, desktop or laptop operating system, mainframe operating system, or any other proprietary or open-source operating system.

The data storage 134 may further include one or more database management systems (DBMS) 144 for accessing, retrieving, storing, and/or manipulating data stored in one or more datastores. The DBMS 144 may use any of a variety of database models (e.g., relational model, object model, etc.) and may support any of a variety of query languages.

The data storage 134 may additionally include various other program modules that may include computer-executable instructions for supporting a variety of associated functionality. For example, the data storage 134 may include one or more user application(s) 146 and/or one or more WiDi transmitter(s) 148.

The user application(s) 146 may include computer-executable instructions that in response to execution by the processor(s) 132 cause operations to be performed including executing of different functionality specific to the application(s) 150. The user application(s) 146 may receive or otherwise retrieve content from local storage and/or from a remote device such one or more the content server(s) 110. For example, the user application(s) 146 may receive streaming video from a file sharing web site or may retrieve information from an email server or the like.

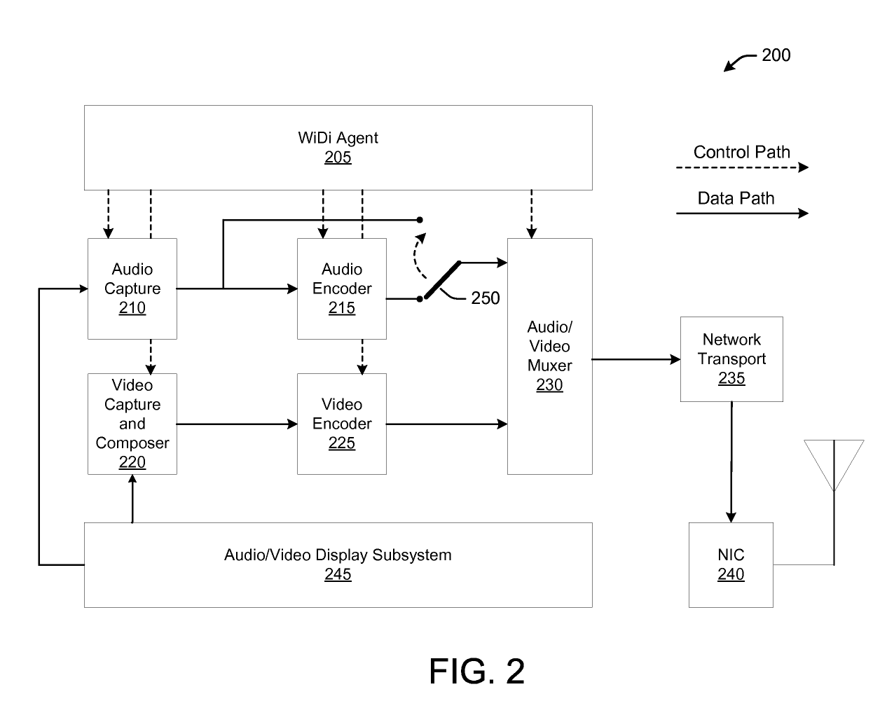

The WiDi transmitter(s) 148 may include computer-executable instructions that in response to execution by the processor(s) 132 cause operations to be performed including capturing audio and video data. The WiDi transmitter 148 may capture audio packets and determine whether the audio packets are silent or have no audio. If the audio packets are silent, then the WiDi transmitter 148 may enable audio skip functionality. If the audio packets are not silent, the WiDi transmitter 148 may encode and transmit the audio packets to a WiDi receiver. An example configuration and further functionality of the WiDi transmitter 148 are described in relation to FIG. 2 below.

Those of ordinary skill in the art will appreciate that any of the components of the system architecture 100 may include alternate and/or additional hardware, software, or firmware components beyond those described or depicted without departing from the scope of the disclosure. More particularly, it should be appreciated that hardware, software, or firmware components depicted or described as forming part of any of the illustrative components of the system architecture 100, and the associated functionality that such components support, are merely illustrative and that some components may not be present or additional components may be provided in various embodiments. While various program modules have been depicted and described with respect to various illustrative components of the system architecture 100, it should be appreciated that the functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of hardware, software, and/or firmware for implementing the functionality. Accordingly, it should be appreciated that the functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Further, while certain modules may be depicted and described as sub-modules of another module, in certain embodiments, such modules may be provided as independent modules.

FIG. 2 is a block diagram including various hardware and software components of an illustrative system architecture 200 for a WiDi transmitter 148 in accordance with one or more embodiments of the disclosure. A WiDi transmitter 148 may include a WiDi agent 205, an audio capture module 210, an audio encoder 215, a video capture and composer (VCC) 220, a video encoder 225, an audio/video multiplexer (muxer) 230, an audio/video display subsystem 245, a network transport module 235, and/or a network interface controller (NIC) 240. The WiDi agent 205 may be responsible for the configuration setup and control of the media or audio/video pipeline, as depicted by the control path lines indicated in FIG. 2. The WiDi agent 205 may transmit instructions to various components within the architecture 200 of the WiDi transmitter 148. The audio/video display subsystem 245 may transfer the audio raw data and video raw data from audio driver and graphic driver to audio capture module 210 and/or a VCC 220. The audio capture module 210 may capture audio packets received from the audio/video display subsystem 245. In some embodiments, the audio capture module 210 may associate each received audio packet with a timestamp. In some embodiments, the audio capture module 210 may determine if the audio packet is silent or contains no audio. If the audio is not silent, the audio packets may be transmitted to the audio encoder 215. The audio encoder 215 may apply audio compression techniques, such as advanced audio coding (ACC) to the received audio packets. If the audio is silent, the audio may bypass the audio encoder 215.

The WiDi transmitter 148 may include an audio bypass 250. The audio bypass 250 may enable the WiDi transmitter 148 to skip audio compression (e.g., ACC) to enable transmission of pulse code modulation (PCM) audio. In some embodiments, the transmission of PCM audio may be eliminated if the audio is determined to be silent.

The VCC 220 may capture video packets received from the audio/video display subsystem 245. In some embodiments, the VCC 220 may associate each received video packets with a timestamp. In some embodiments, the VCC 220 may transmit the video packets to the video encoder 225, which may apply one or more video compression techniques to the video packets. The video encoder 225 may then transmit the encoded video data to the audio/video muxer 230.

The audio/video muxer 230 may receive encoded audio packets from the audio encoder 215, unencoded audio packets from the audio capture module 210, and/or encoded video data from the video encoder 225. The audio/video muxer 230 may multiplex the received audio and/or video data to generate a transport stream, such as an MPEG2 compliant transport stream. The transport stream may then be transmitted to the network transport module 235 to be packetized and transmitted to a WiDi receiver 106 over a wireless link via a network interface controller (NIC) 240.

Those of ordinary skill in the art will appreciate that the illustrative system architecture 200 is provided by way of example only. Numerous other operating environments, system architectures, and device configurations are within the scope of this disclosure. Other embodiments of the disclosure may include fewer or greater numbers of components and/or devices and may incorporate some or all of the functionality described with respect to the illustrative system architecture 200, or additional functionality.

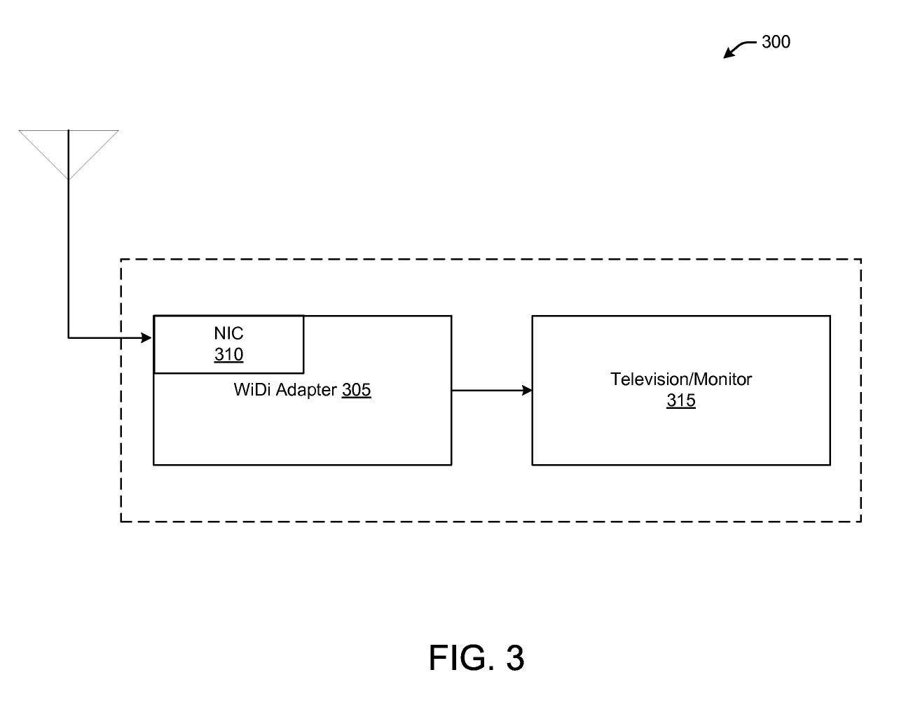

FIG. 3 is a block diagram including various hardware and software components of an illustrative system architecture 300 for a WiDi receiver 106 in accordance with one or more embodiments of the disclosure. In some embodiments, the WiDi receiver 106 may be an SoC adapter, a soft receiver executing on a computing device, and/or integrated with an high definition TV 108. A WiDi receiver 106 may include a WiDi adapter 305 which may include an NIC 310. The WiDi adapter 305 may receive data packets over a wireless network via NIC 310. The packets may be buffered and unpacketized by the WiDi adapter 305 to retrieve a transport stream. The WiDi adapter 305 may apply a sequence of operations (e.g., demuxing and decoding the transport stream) to recover audio and video frames to render to a display device and/or speakers. The WiDi adapter 305 may then transmit the audio and video frames to the display devices and/or speakers for rendering. In some embodiments, the audio and video frames may be transported over an HDMI connection.

### Illustrative Processes

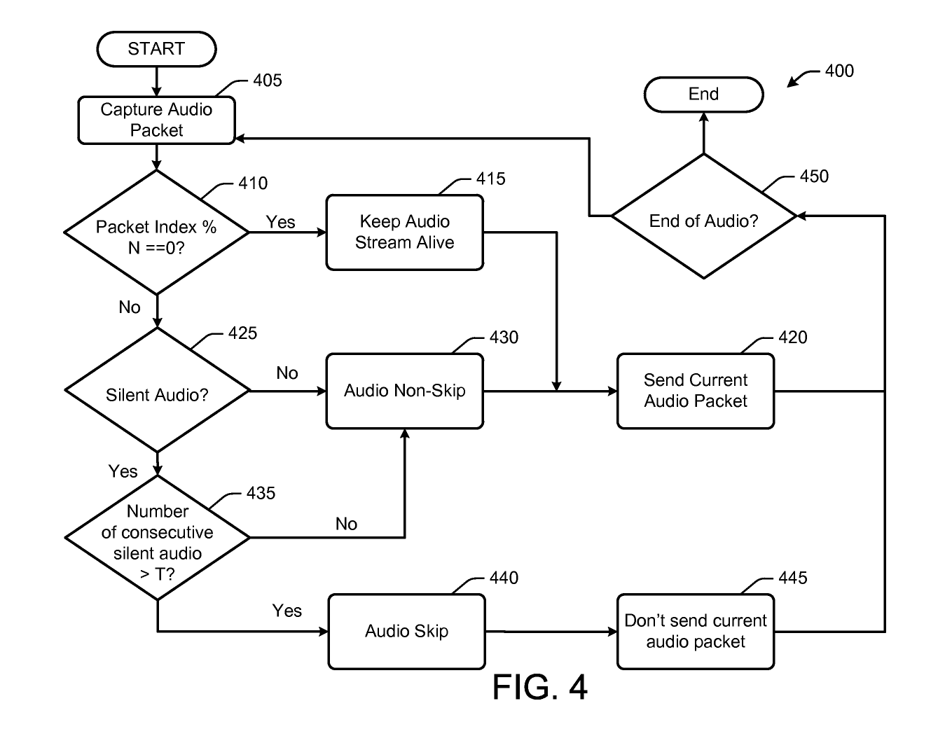

FIG. 4 is a process flow diagram of an illustrative method 400 for audio skip in a WiDi in accordance with one or more embodiments of the disclosure. At block 405, one or more audio packets may be captured. In some embodiments, the audio packets may be received from an audio/video display subsystem 245 by an audio capture module 210. At block 410, the modulo of an index associated with a packet and a pre-determined number N may be determined. If the modulo of an index associated with a packet and a pre-determined number N is determined to equal 0, then the process proceeds to block 415. For example, at block 410, if N is set to 3, then every packet with an index divisible by three may be transmitted to block 415 to keep the connection between the WiDi transmitter 148 and the WiDi receiver 106 active. From block 415, the process may proceed to block 420, where the audio packet may be transmitted to the WiDi receiver 106.

Although depicted in the process as a modulo function, block 410 represents a mechanism to transmit an audio packet, regardless of whether it is silent or not silent, to the WiDi receiver 106 in order to maintain the connection. In some embodiments, block 410 may designate every Nth packet to be transmitted. In some embodiments, block 410 may designate an audio packet be transmitted at pre-determined time intervals (e.g., every 5 seconds).

If at block 410, the modulo of an index associated with a packet and a pre-determined number N is determined to not equal 0, then the process may proceed to block 425. At block 425, a determination is made as to whether the audio packet is silent or not silent. If the audio packet is not silent, then the process proceeds to block 430, where the audio non-skip mode is entered. An audio non-skip mode may include encoding the audio packet and transmitting the audio packet to a wireless display (WiDi) receiver.

At block 420, arrived from either block 415 or block 430, an audio packet may be transmitted and then the process may proceed to block 450.

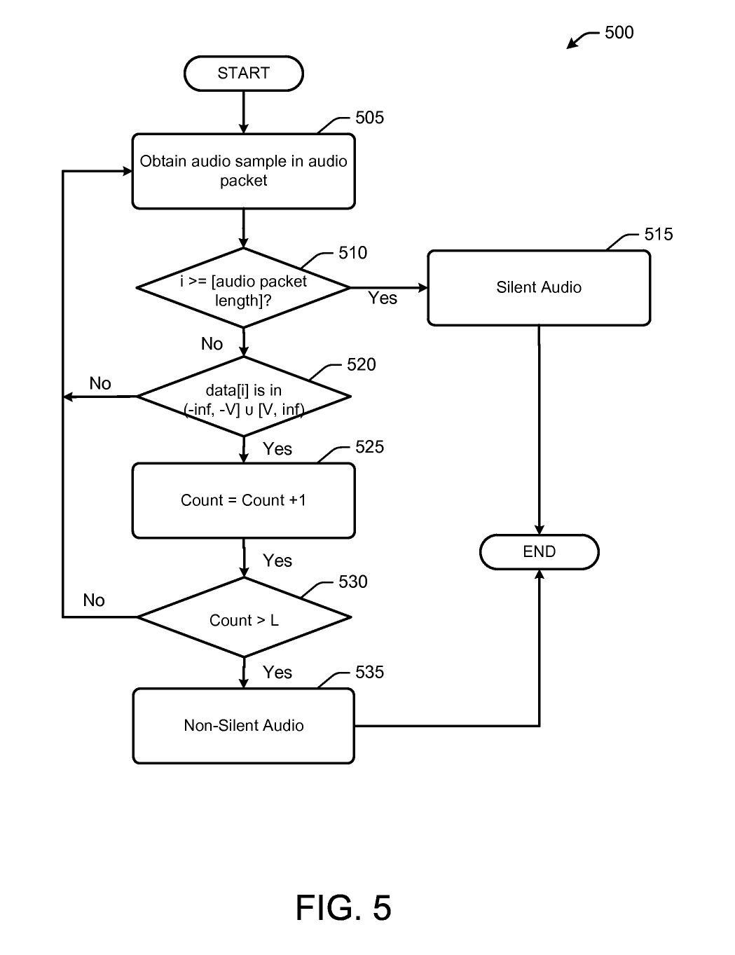

If the audio packet is silent, then the process proceeds to block 435. An example method to determine whether an audio packet is silent is described in further detail with relation to FIG. 5.

At block 435, a determination is made as to whether an indicator has exceeded a pre-determined quantity threshold, T. The indicator may indicate the number of consecutive silent audio packets. For example, if the pre-determined quantity threshold is 200, then block 435 is determining to see if there have been 200 consecutive silent audio packets detected. If the indicator does not exceed the threshold, then the processed proceeds to block 430. In some embodiments, the indicator may be incremented to maintain an accurate count of the number of consecutive silent audio packets. If the next audio packet is not silent, the indicator may be reset to 0. If the indicator does exceed the threshold, the process may proceed to block 440, where an audio skip mode is initiated and/or entered. In some embodiments, the audio skip mode may include transmitting the audio packet to a wireless display (WiDi) receiver 106 without encoding the audio packet or declining to transmit the audio packet to the WiDi receiver 106.

The process may then proceed to block 450.

At block 450, a determination is made as to whether all the audio has been captured and processed. If yes, then the process may terminate. If not, then the process may proceed back to block 405, until all the audio packets have been processed.

FIG. 5 is a process flow diagram of an illustrative method 500 for detecting if an audio packet is silent in accordance with one or more embodiments of the disclosure. An audio packet may include many audio samples. At block 505, the WiDi transmitter 148 may obtain or otherwise receive the audio samples from an audio packet. At block 510, a determination is made as to whether the end of a packet has been reached. For example, in block 510, a determination may be made as to whether an index associated with an audio sample of an audio packet is greater or equal to the audio packet length. If the index associated with the audio sample is greater, then the process may proceed to block 515, where the audio packet is determined to be silent audio and the process terminates. If the index associated with the audio sample is not greater than the audio packet length, then the process may proceed to block 520.

At block 520, a determination is made as to whether the absolute value of data within the audio sample at index i, exceeds a volume threshold V, where i may start at 0. Here, the determination is made by comparing the absolute value of the data at index i to V to determine if the absolute value of data at i exceeds the threshold V. If the absolute value of data at i does not exceed V, then the process may proceed back to block 505. If the absolute value of data at i does exceed V, then the process may proceed back to block 525, where a counter is incremented. The counter may indicate the number of audio samples within an audio packet which their absolute value of data has exceeded V. The process may then proceed to block 530, where a determination is made as to whether the count C is greater than a predetermined quantity threshold L. L may be a threshold that indicates whether an audio packet is silent or non-silent. If at block 530, C is determined to be greater than L, then the process may proceed to block 535, where the audio packet is determined to be non-silent. If at block 530, C is determined to be less than L, then the process may proceed back to 505.

As an illustrative example, an audio packet may contain 2000 audio samples. Of those 2000 audio samples, 350 of them may have exceeded the volume threshold V, which would mean than C=350. If L=1000, then the audio packet may be determined to be deemed silent. If C=1001, then the audio packet may be determined to be non-silent.

In one embodiment, a non-transitory computer-readable medium may store computer-executable instructions which, when executed by a processor, may cause the processor to perform operations including capturing a plurality of audio packets; and analyzing each of the plurality of audio packets. Analyzing each of the plurality of audio packets may include determining whether an audio packet of the plurality of audio packets is silent; in response to determining the audio packet of the plurality of audio packets is not silent, entering an audio non-skip mode; in response to determining the audio packet of the plurality of audio packets is silent, determining whether an indicator has exceeded a threshold, wherein the indicator indicates a sequential number of silent audio packets; in response to the indicator indicating the indicator exceeds the threshold, entering an audio skip mode; and in response to the indicator indicating the indicator has not exceeded the threshold, entering the audio non-skip mode.

In one aspect of an embodiment, each audio packet of the plurality of audio packets comprises one or more audio samples.

In one aspect of an embodiment, determining whether the audio packet of the plurality of audio packets is silent may include analyzing each of the one or more audio samples, wherein analyzing each of the one or more audio samples may include determining whether an audio sample of the one or more audio samples exceeds a volume threshold; and in response to determining that the audio sample of the one or more audio samples exceeds the volume threshold, incrementing a counter; and determining whether the counter exceeds a predetermined quantity threshold; in response to determining the counter exceeds the predetermined quantity threshold, indicating the audio packet of the plurality of audio packets is not silent; and in response to determining the counter does not exceed the predetermined quantity threshold, indicating the audio packet of the plurality of audio packets is silent.

In another aspect of an embodiment, the operations may further include transmitting the audio packet of the plurality of audio packets to a wireless display (WiDi) receiver at predetermined intervals.

In another aspect of an embodiment, the audio non-skip mode may include encoding the audio packet of the plurality of audio packets; and transmitting the audio packet of the plurality of audio packets to a wireless display (WiDi) receiver.

In another aspect of an embodiment, the audio skip mode may include transmitting the audio packet of the plurality of audio packets to a wireless display (WiDi) receiver without encoding the audio packet; or declining transmission of the audio packet of the plurality of audio packets to the WiDi receiver.

In another aspect of an embodiment, the operations may further include determining if in audio skip mode or audio non-skip mode; and in response to determining if in audio skip mode and receiving the audio packet of the plurality of packets that is not silent, entering the audio non-skip mode.

In another embodiment, a computer-implemented method may be provided. The computer-implemented method may include capturing, by a device comprising one or more processors, a plurality of audio packets; and analyzing, by the device, each of the plurality of audio packets. Analyzing each of the plurality of audio packets may include determining whether an audio packet of the plurality of audio packets is silent; in response to determining the audio packet of the plurality of audio packets is not silent, entering an audio non-skip mode; in response to determining the audio packet of the plurality of audio packets is silent, determining whether an indicator has exceeded a threshold, wherein the indicator indicates a sequential number of silent audio packets; in response to the indicator indicating the indicator exceeds the threshold, entering an audio skip mode; and in response to the indicator indicating the indicator has not exceeded the threshold, entering the audio non-skip mode.

In one aspect of an embodiment, each audio packet of the plurality of audio packets may include one or more audio samples.

In one aspect of an embodiment, determining whether the audio packet of the plurality of audio packets is silent may include analyzing, by the device, each of the one or more audio samples, wherein analyzing each of the one or more audio samples may include determining whether an audio sample of the one or more audio samples exceeds a volume threshold; and in response to determining that the audio sample of the one or more audio samples exceeds the volume threshold, incrementing a counter; and determining whether the counter exceeds a predetermined quantity threshold; in response to determining the counter exceeds the predetermined quantity threshold, indicating the audio packet of the plurality of audio packets is not silent; and in response to determining the counter does not exceed the predetermined quantity threshold, indicating the audio packet of the plurality of audio packets is silent.

In another aspect of an embodiment, the computer-implemented method may include transmitting, by the device, the audio packet of the plurality of audio packets to a wireless display (WiDi) receiver at predetermined intervals.

In another aspect of an embodiment, the audio non-skip mode may include encoding, by the device, the audio packet of the plurality of audio packets; and transmitting, by the device, the audio packet of the plurality of audio packets to a wireless display (WiDi) receiver.

In another aspect of an embodiment, the audio skip mode may include transmitting, by the device, the audio packet of the plurality of audio packets to a wireless display (WiDi) receiver without encoding the audio packet; or declining, by the device, transmission of the audio packet of the plurality of audio packets to the WiDi receiver.

In another aspect of an embodiment, the computer-implemented method may include determining if in audio skip mode or audio non-skip mode; and in response to determining if in audio skip mode and receiving the audio packet of the plurality of packets that is not silent, entering the audio non-skip mode.

In another embodiment, a system may be provided. The system may include at least one memory storing computer-executable instructions; and at least one processor, wherein the at least one processor may be configured to access the at least one memory and to execute the computer-executable instructions to capture a plurality of audio packets; and analyze each of the plurality of audio packets, wherein to analyze each of the plurality of audio packets may include determining whether an audio packet of the plurality of audio packets is silent; in response to determining the audio packet of the plurality of audio packets is not silent, entering an audio non-skip mode; in response to determining the audio packet of the plurality of audio packets is silent, determine whether an indicator has exceeded a threshold, wherein the indicator indicates a sequential number of silent audio packets; in response to the indicator indicating the indicator exceeds the threshold, entering an audio skip mode; and in response to the indicator indicating the indicator has not exceeded the threshold, entering the audio non-skip mode.

In another aspect of an embodiment, each audio packet of the plurality of audio packets may include one or more audio samples.

In another aspect of an embodiment, determining whether the audio packet of the plurality of audio packets is silent may include analyzing each of the one or more audio samples, wherein analyzing each of the one or more audio samples may include determining whether an audio sample of the one or more audio samples exceeds a volume threshold; and in response to determining that the audio sample of the one or more audio samples exceeds the volume threshold, incrementing a counter; and determining whether the counter exceeds a predetermined quantity threshold; in response to determining the counter exceeds the predetermined quantity threshold, indicating the audio packet of the plurality of audio packets is not silent; and in response to determining the counter does not exceed the predetermined quantity threshold, indicating the audio packet of the plurality of audio packets is silent.

In another aspect of an embodiment, the at least one processor may be further configured to execute the computer-executable instructions to transmit the audio packet of the plurality of audio packets to a wireless display (WiDi) receiver at predetermined intervals.

In another aspect of an embodiment, the audio non-skip mode may include encoding the audio packet of the plurality of audio packets; and transmitting the audio packet of the plurality of audio packets to a wireless display (WiDi) receiver.

In another aspect of an embodiment, the audio skip mode may include transmitting the audio packet of the plurality of audio packets to a wireless display (WiDi) receiver without encoding the audio packet; or declining transmission of the audio packet of the plurality of audio packets to the WiDi receiver.

In another aspect of an embodiment, the at least one processor may be further configured to execute the computer-executable instructions to detect if in the audio skip mode or the audio non-skip mode; in response to a detection of the audio skip mode and receipt of the audio packet of the plurality of packets that is not silent, enter the audio non-skip mode.

In another embodiment, an apparatus may be provided. The apparatus may include at least one antenna; at least one transceiver; at least one memory storing computer-executable instructions; and at least one processor, wherein the at least one processor is configured to access the at least one memory and to execute the computer-executable instructions to capture a plurality of audio packets; and analyze each of the plurality of audio packets, wherein to analyze each of the plurality of audio packets may include determining whether an audio packet of the plurality of audio packets is silent; in response to determining the audio packet of the plurality of audio packets is not silent, entering an audio non-skip mode; in response to determining the audio packet of the plurality of audio packets is silent, determine whether an indicator has exceeded a threshold, wherein the indicator indicates a sequential number of silent audio packets; in response to the indicator indicating the indicator exceeds the threshold, entering an audio skip mode; and in response to the indicator indicating the indicator has not exceeded the threshold, entering the audio non-skip mode.

In another aspect of an embodiment, each audio packet of the plurality of audio packets may include one or more audio samples.

In another aspect of an embodiment, determining whether the audio packet of the plurality of audio packets is silent may include analyzing each of the one or more audio samples, wherein analyzing each of the one or more audio samples may include determining whether an audio sample of the one or more audio samples exceeds a volume threshold; and in response to determining that the audio sample of the one or more audio samples exceeds the volume threshold, incrementing a counter; and determining whether the counter exceeds a predetermined quantity threshold; in response to determining the counter exceeds the predetermined quantity threshold, indicating the audio packet of the plurality of audio packets is not silent; and in response to determining the counter does not exceed the predetermined quantity threshold, indicating the audio packet of the plurality of audio packets is silent.

In another aspect of an embodiment, the at least one processor may be further configured to execute the computer-executable instructions to transmit the audio packet of the plurality of audio packets to a wireless display (WiDi) receiver at predetermined intervals.

In another aspect of an embodiment, the audio non-skip mode may include encoding the audio packet of the plurality of audio packets; and transmitting the audio packet of the plurality of audio packets to a wireless display (WiDi) receiver.

In another aspect of an embodiment, the audio skip mode may include transmitting the audio packet of the plurality of audio packets to a wireless display (WiDi) receiver without encoding the audio packet; or declining transmission of the audio packet of the plurality of audio packets to the WiDi receiver.

In another embodiment, a system may be provided. The system may include a means for capturing a plurality of audio packets; and a means analyzing each of the plurality of audio packets, wherein analyzing may include a means for determining whether an audio packet of the plurality of audio packets is silent; in response to determining the audio packet of the plurality of audio packets is not silent, a means for entering an audio non-skip mode; in response to determining the audio packet of the plurality of audio packets is silent, a means for determining whether an indicator has exceeded a threshold, wherein the indicator indicates a sequential number of silent audio packets; in response to the indicator indicating the indicator exceeds the threshold, a means for entering an audio skip mode; and in response to the indicator indicating the indicator has not exceeded the threshold, a means for entering the audio non-skip mode.

In another aspect of an embodiment, each audio packet of the plurality of audio packets may include one or more audio samples.

In another aspect of an embodiment, the means for determining whether the audio packet of the plurality of audio packets is silent may include a means for analyzing each of the one or more audio samples, wherein analyzing each of the one or more audio samples may include a means for determining whether an audio sample of the one or more audio samples exceeds a volume threshold; and in response to determining that the audio sample of the one or more audio samples exceeds the volume threshold, a means for incrementing a counter; and a means for determining whether the counter exceeds a predetermined quantity threshold; in response to determining the counter exceeds the predetermined quantity threshold, a means for indicating the audio packet of the plurality of audio packets is not silent; and in response to determining the counter does not exceed the predetermined quantity threshold, a means for indicating the audio packet of the plurality of audio packets is silent.

In another aspect of an embodiment, the system may include a means for transmitting the audio packet of the plurality of audio packets to a wireless display (WiDi) receiver at predetermined intervals.

In another aspect of an embodiment, the audio non-skip mode may include a means for encoding the audio packet of the plurality of audio packets; and a means for transmitting the audio packet of the plurality of audio packets to a wireless display (WiDi) receiver.

In another aspect of an embodiment, the audio skip mode may include a means for transmitting the audio packet of the plurality of audio packets to a wireless display (WiDi) receiver without encoding the audio packet; or a means for declining transmission of the audio packet of the plurality of audio packets to the WiDi receiver.

In another aspect of an embodiment, the system may include a means for determining if in audio skip mode or audio non-skip mode; and in response to determining if in audio skip mode and receiving the audio packet of the plurality of packets that is not silent, a means for entering the audio non-skip mode.

### CONCLUSION

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A non-transitory computer-readable medium storing computer-executable instructions which, when executed by a processor, cause the processor to perform operations comprising:
capturing a plurality of audio packets; and
analyzing each of the plurality of audio packets, wherein analyzing comprises:
determining whether an audio packet of the plurality of audio packets is silent;
in response to determining the audio packet of the plurality of audio packets is not silent,
entering an audio non-skip mode;
in response to determining the audio packet of the plurality of audio packets is silent,
determining whether an indicator has exceeded a threshold, wherein the indicator indicates a sequential number of silent audio packets;
in response to the indicator indicating the indicator exceeds the threshold, entering an audio skip mode; and
in response to the indicator indicating the indicator has not exceeded the threshold, entering the audio non-skip mode.

2. The non-transitory computer-readable medium of claim 1, wherein each audio packet of the plurality of audio packets comprises one or more audio samples.

3. The non-transitory computer-readable medium of claim 2, wherein determining whether the audio packet of the plurality of audio packets is silent comprises:
analyzing each of the one or more audio samples, wherein analyzing each of the one or more audio samples comprises:
determining whether an audio sample of the one or more audio samples exceeds a volume threshold; and
in response to determining that the audio sample of the one or more audio samples exceeds the volume threshold, incrementing a counter; and
determining whether the counter exceeds a predetermined quantity threshold;
in response to determining the counter exceeds the predetermined quantity threshold, indicating the audio packet of the plurality of audio packets is not silent; and
in response to determining the counter does not exceed the predetermined quantity threshold, indicating the audio packet of the plurality of audio packets is silent.

4. The non-transitory computer-readable medium of claim 1, wherein the operations further comprise:
transmitting the audio packet of the plurality of audio packets to a wireless display (WiDi) receiver at predetermined intervals.

5. The non-transitory computer-readable medium of claim 1, wherein the audio non-skip mode comprises:
encoding the audio packet of the plurality of audio packets; and
transmitting the audio packet of the plurality of audio packets to a wireless display (WiDi) receiver.

6. The non-transitory computer-readable medium of claim 1, wherein the audio skip mode comprises:
transmitting the audio packet of the plurality of audio packets to a wireless display (WiDi) receiver without encoding the audio packet; or
declining transmission of the audio packet of the plurality of audio packets to the WiDi receiver.

7. The non-transitory computer-readable medium of claim 1, wherein the operations further comprise:
determining if in audio skip mode or audio non-skip mode; and
in response to determining if in audio skip mode and receiving the audio packet of the plurality of packets that is not silent, entering the audio non-skip mode.

8. A computer-implemented method comprising:
capturing, by a device comprising one or more processors, a plurality of audio packets; and
analyzing, by the device, each of the plurality of audio packets, wherein analyzing comprises:
determining whether an audio packet of the plurality of audio packets is silent;
in response to determining the audio packet of the plurality of audio packets is not silent, entering an audio non-skip mode;
in response to determining the audio packet of the plurality of audio packets is silent, determining whether an indicator has exceeded a threshold, wherein the indicator indicates a sequential number of silent audio packets;
in response to the indicator indicating the indicator exceeds the threshold, entering an audio skip mode; and
in response to the indicator indicating the indicator has not exceeded the threshold, entering the audio non-skip mode.

9. The computer-implemented method of claim 8, wherein each audio packet of the plurality of audio packets comprises one or more audio samples.

10. The computer-implemented method of claim 9, wherein determining whether the audio packet of the plurality of audio packets is silent comprises:
analyzing, by the device, each of the one or more audio samples, wherein analyzing each of the one or more audio samples comprises:
determining whether an audio sample of the one or more audio samples exceeds a volume threshold; and
in response to determining that the audio sample of the one or more audio samples exceeds the volume threshold, incrementing a counter; and
determining whether the counter exceeds a predetermined quantity threshold;
in response to determining the counter exceeds the predetermined quantity threshold, indicating the audio packet of the plurality of audio packets is not silent; and
in response to determining the counter does not exceed the predetermined quantity threshold, indicating the audio packet of the plurality of audio packets is silent.

11. The computer-implemented method of claim 8, further comprising:
transmitting, by the device, the audio packet of the plurality of audio packets to a wireless display (WiDi) receiver at predetermined intervals.

12. The computer-implemented method of claim 8, wherein the audio non-skip mode comprises:
encoding, by the device, the audio packet of the plurality of audio packets; and
transmitting, by the device, the audio packet of the plurality of audio packets to a wireless display (WiDi) receiver.

13. The computer-implemented method of claim 8, wherein the audio skip mode comprises:
transmitting, by the device, the audio packet of the plurality of audio packets to a wireless display (WiDi) receiver without encoding the audio packet; or
declining, by the device, transmission of the audio packet of the plurality of audio packets to the WiDi receiver.

14. The computer-implemented method of claim 8, further comprising:
determining if in audio skip mode or audio non-skip mode; and
in response to determining if in audio skip mode and receiving the audio packet of the plurality of packets that is not silent, entering the audio non-skip mode.

15. A system comprising:
at least one memory storing computer-executable instructions; and
at least one processor, wherein the at least one processor is configured to access the at least one memory and to execute the computer-executable instructions to:
capture a plurality of audio packets; and
analyze each of the plurality of audio packets, wherein to analyze each of the plurality of audio packets comprises:
determining whether an audio packet of the plurality of audio packets is silent;
in response to determining the audio packet of the plurality of audio packets is not silent, entering an audio non-skip mode;
in response to determining the audio packet of the plurality of audio packets is silent, determine whether an indicator has exceeded a threshold,
wherein the indicator indicates a sequential number of silent audio packets;
in response to the indicator indicating the indicator exceeds the threshold, entering an audio skip mode; and
in response to the indicator indicating the indicator has not exceeded the threshold, entering the audio non-skip mode.

16. The system of claim 15, wherein each audio packet of the plurality of audio packets comprises one or more audio samples.

17. The system of claim 16, wherein determining whether the audio packet of the plurality of audio packets is silent comprises:
analyzing each of the one or more audio samples, wherein analyzing each of the one or more audio samples comprises:
determining whether an audio sample of the one or more audio samples exceeds a volume threshold; and
in response to determining that the audio sample of the one or more audio samples exceeds the volume threshold, incrementing a counter; and
determining whether the counter exceeds a predetermined quantity threshold;
in response to determining the counter exceeds the predetermined quantity threshold, indicating the audio packet of the plurality of audio packets is not silent; and
in response to determining the counter does not exceed the predetermined quantity threshold, indicating the audio packet of the plurality of audio packets is silent.

18. The system of claim 15, wherein the at least one processor is further configured to execute the computer-executable instructions to:
transmit the audio packet of the plurality of audio packets to a wireless display (WiDi) receiver at predetermined intervals.

19. The system of claim 15, wherein the audio non-skip mode comprises:
encoding the audio packet of the plurality of audio packets; and
transmitting the audio packet of the plurality of audio packets to a wireless display (WiDi) receiver.

20. The system of claim 15, wherein the audio skip mode comprises:
transmitting the audio packet of the plurality of audio packets to a wireless display (WiDi) receiver without encoding the audio packet; or
declining transmission of the audio packet of the plurality of audio packets to the WiDi receiver.

21. The system of claim 15, wherein the at least one processor is further configured to execute the computer-executable instructions to:
detect if in the audio skip mode or the audio non-skip mode;
in response to a detection of the audio skip mode and receipt of the audio packet of the plurality of packets that is not silent, enter the audio non-skip mode.
